(19) United States
(12) Patent Application Publication
(10) Pub. No.: US 2005/0177866 A1
(43) Pub. Date: Aug. 11, 2005

(54) Method and system for acceleration of secure socket layer transactions in a network

(76) Inventor: Steven T. Kirsch, Los Altos Hills, CA (US)

Correspondence Address: SCHNECK & SCHNECK, P.O. BOX 2-E, SAN JOSE, CA, 95109-0005, US

(21) Appl. No.: 10/775,804

(22) Filed: Feb. 9, 2004

(51) Int. Cl. H04L 9/00

(52) U.S. Cl. 726/3; 713/201

(57) ABSTRACT

A system and method of accelerating delivery of SSL webpages. A client proxy associated with a client browser rewrites links to secure websites in a webpage before returning the webpage to the browser. The links are rewritten such that they are recognized and processed as a request for a secure webpage by another proxy in the network. The proxy returns the request to its original format and requests the page. The proxy establishes an SSL session with the server and decrypts and compresses the response before sending it to the client proxy, where the response is scanned for any links to secure webpages that should be rewritten before the response is returned to the client. This approach, which is transparent to the client, may be combined with other solutions, for instance, certain compression techniques and/or network architectures, for further reducing bandwidth and communication latency.

### FIELD OF THE INVENTION

This invention is concerned with accelerating secure transactions within a network.

### BACKGROUND OF THE INVENTION

The Secure Sockets Layer (SSL) protocol was developed by Netscape™ to enable the secure transmission of data over TCP/IP networks. SSL (now also known as Transport Layer Security (TLS) since the Internet Engineering Task Force (IETF) has taken over responsibility for the SSL standard) is commonly used to support secure transactions on the World Wide Web (Web). As more and more financial and confidential transactions are conducted using the Web, the ability to secure these transactions using SSL is increasingly important.

SSL supports multiple applications. The protocol runs above TCP/IP and below the application layer, which includes protocols such as the HyperText Transport Protocol (HTTP), the Internet Messaging Access Protocol (IMAP), the Simple Mail Transfer Protocol (SMTP), and the File Transfer Protocol (FTP). The SSL protocol consists of a set of routines for providing security services such as authentication and encryption.

Referring to FIG. 1, when a secure webpage is requested by a Web browser (block 10), such as (Netscape NAVIGATOR) or Microsoft Internet Explorer, the request is received at a server at TCP port 443 (unsecured session requests are received at TCP port 80). The server then sends the browser its digital certificate (block 12). The browser then checks the digital certificate (block 14). Provided the certificate is valid, the browser and server then negotiate a session key (block 16). The secure channel is established and all data transmitted over that channel is encrypted with the session key (block 18). When the browser receives the encrypted webpage, it decrypts it using the session key (block 20).

There is a high processing cost associated with providing security via SSL transactions. Authentication and encryption in secure transactions both require much more processing power than is required in non-secure transactions. This processing requirement can affect the performance of servers responding to requests for secure transactions; this effect is noticeable to Web users due to the increased amount of time that may be required to conduct secure transactions. Hardware accelerators which off-load the tasks of establishing an SSL session and encrypting/decrypting data from a server to the accelerator are widely available, though they are not employed at all servers which handle requests for secure webpages.

Even if hardware SSL accelerators are used to reduce the amount of time required to complete a secure transaction, the requests and responses sent from the client and server are still likely to be affected by factors that create network bottlenecks and slow the delivery of Webpages in the network. These factors include: slow servers, modem and network latency, and the bandwidth of the communication pipe.

It would advantageous to provide a transparent software solution to SSL acceleration that could be employed at the client. It would also be advantageous to provide a solution to SSL acceleration which could be combined with other approaches to reducing the bandwidth necessary to deliver SSL webpages as well as reducing communication latency within the network.

### SUMMARY OF THE INVENTION

These needs have been met by a system and method of accelerating SSL webpages in which a client proxy associated with a client browser rewrites links to secure websites in a webpage requested by the client browser before the page is returned to the client browser; the links are rewritten from their original format such that they are recognized and processed as requests for SSL webpages by another proxy in the network, in one embodiment a device intermediating between the client and server. If a secure website is requested, the request is recognized by the other proxy which returns the request to its original format before requesting the page. The proxy establishes an SSL session with the server and decrypts and compresses the response before sending it to the client proxy, where the response is scanned and any links to secure webpages are rewritten before the response is returned to the client. This approach is transparent to the client.

In other embodiments, this approach to SSL acceleration may be combined with other solutions to reduce bandwidth and communication latency, for instance, by using certain compression techniques and network architectures.

### BRIEF DESCRIPTION OF THE DRAWINGS

FIG. 1 is a flowchart showing the prior art approach to establishing and conducting an SSL session.

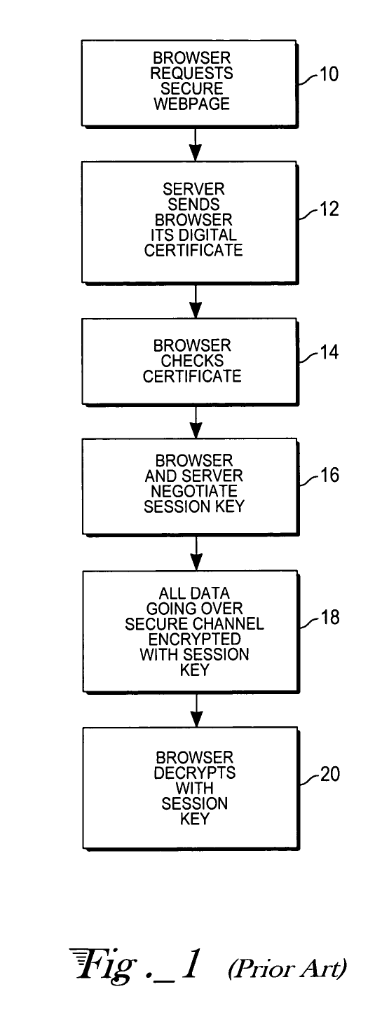

FIG. 2 is a block diagram showing a potential network configuration in accordance with the invention.

FIG. 3 is a flowchart showing acceleration of SSL transactions in accordance with the invention.

### DETAILED DESCRIPTION

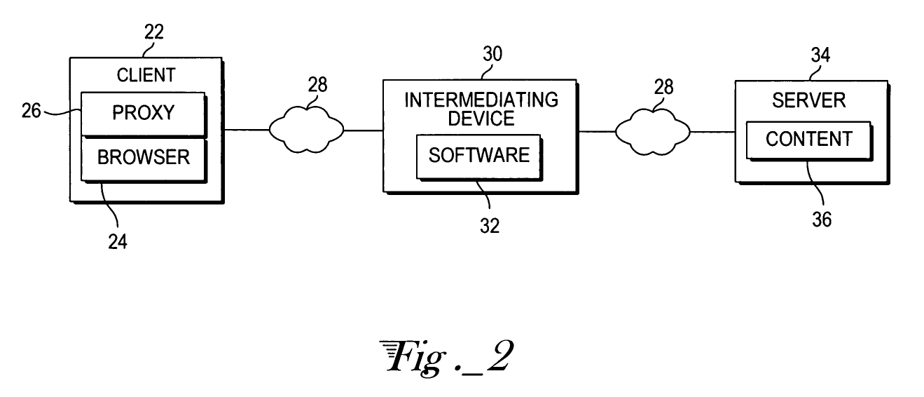

In FIG. 2, a client device 22 (such as a personal computer or other computing device) having a Web browser 24, such as Netscape NAVIGATOR or Microsoft Internet Explorer, and software acting as a client proxy 26, is connected via a network connection 28 to a device 30 intermediating between the client and a server 34 in the network 28. (In other embodiments, the client proxy may be running on another machine.) The device 30 may be a server or any other computing device. The device 30 is running specialized software 32, discussed in greater detail below, which enables the device 30 to handle requests for secure Webpages from the client 22 and then process the webpage received from the server 34 as required before returning the webpage to the client proxy 26; this software 32 may also decrypt and compress the webpage before returning it to the client proxy 26. In other embodiments, the device or server may be associated with hardware SSL accelerators. The server 34 contains content 36 which is requested by the client 22 (the content 36 may be stored at the server or at a storage device associated with the server 34).

In one embodiment, the client 22 and device 30 are members of a private network, while the server 34 is a member of a public network. In other embodiments, the client 22 is as member of both the private and public networks. In one embodiment, disclosed in U.S. patent application Ser. No. 10/012,743, filed Dec. 7, 2001, which is herein incorporated by reference, the client proxy 26 relays requests from the client 22 to the device 30, which then sends the request to the server 34. The device 30 may contain a cache of content retrieved from the server; the cached content, if current, may be used to assemble at least part of the reply to request for content.

In another embodiment, disclosed in U.S. patent application Ser. No. 10/012,743, the private network is a persistently-connected caching network featuring multiple hubs, or network devices, which are capable of caching material transmitted through the hub as material is sent either from a server or another caching hub in response to a client's request for the material. The network devices may employ a socket layer capable of combining multiple messages from different machines, threads, and/or processes into single TCP/IP packets to be relayed along message hubs in the persistent network. Due to the direct connection between dedicated socket pairs of network members, there is bi-directional asynchronous communication between the network members.

The acceleration of SSL websites is achieved by having the intermediating device, rather than the client, retrieve the secure webpage from the server, and then decrypting and compressing the secure webpage, using either known or proprietary compression techniques, before sending the response to the client proxy.

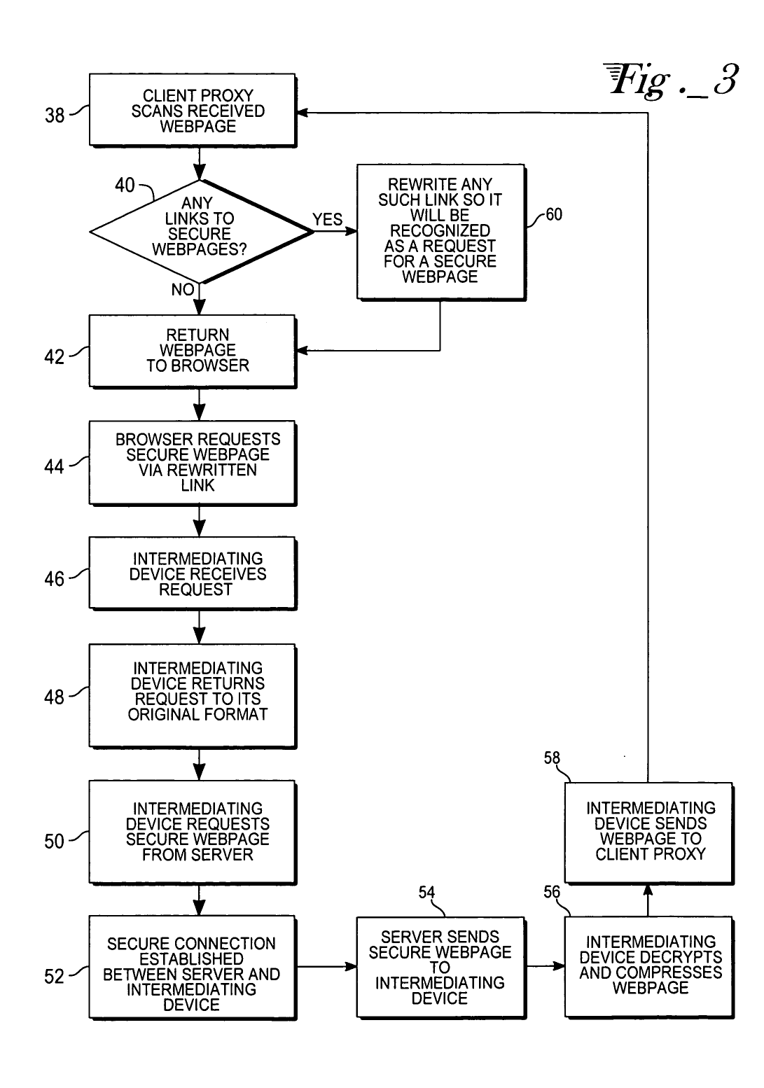

In FIG. 3, the client proxy scans a received webpage (block 38) to determine whether the webpage contains any links to secure webpages (block 40). Secure webpages are indicated, for instance, by the presence of “https,” indicating the use of secure http, in the URL. Any links to secure webpages are rewritten so that the intermediating device can recognize the request is for a secure webpage (block 60). The link can be rewritten from its original format to indicate a request for a secure webpage in several ways. In one embodiment, an https request can be rewritten as an http request as follows: https://www.bank.com/x is rewritten as http://propelsecure.www.bank.com/x. In another embodiment, the https request can be redirected to a subdomain indicating a request for a secure webpage as follows: https://www.bank.com/ is rewritten as https://www.bank.com/propel. Once links to secure webpages in the webpage have been rewritten (block 60), or if there are no links that need to be rewritten (block 40), the webpage is returned to the client's browser (block 42).

A secure webpage is requested by the browser via the rewritten link in the webpage (block 44). This request is sent to the client proxy which sends it on to the intermediating device. The intermediating device receives the request for the webpage (block 46). Where the request from the client is an https request, the client proxy and the intermediating device have to form a secure connection. When the request from the client is an http request, no secure connection needs to be formed. When the client proxy and intermediating device are members of a private network, the private network provides a greater level of security than the public network, so data sent between the server and client proxy outside of an SSL connection is less likely to be compromised than it would be if it were sent over a public network.

Since the links to secure webpages are rewritten as subdomains or controlled domains, any cookies previously sent by a content server to the client will still be sent with the rewritten request. Cookies remain attached to all requests which are passed to the client proxy and the intermediating device.

The device returns the request to its original format (block 48) and requests the secure webpage from the server (block 50). The device and the server establish a secure connection (block 52) and the server sends the secure webpage to the intermediating device (block 54). The intermediating device decrypts the webpage and compresses it (block 56).

Any type of compression scheme may be used. In one embodiment, disclosed in U.S. patent application Ser. No. 10/012,743, which was earlier incorporated by reference, text or pictures are compressed into one or more unique codes, or identifiers, typically 64-bit hash codes. When text is compressed, the text is broken up in one embodiment through use of an HTML parser which breaks on certain HTML tags; in other embodiments, text can be broken up by words or paragraphs. The identifiers and content associated with the identifiers are stored at a database at the encoder (here, the proxy). Where identifiers have been seen in sequence previously by the encoder, that sequence of identifiers is consolidated into a new identifier. The identifiers are then sent to the client proxy, which is associated with a database or cache containing identifiers and content previously received from the encoder (proxy). If an identifier is in the client proxy's database, the client proxy is able to decompress the identifier; otherwise, the client proxy requests the content associated with the identifier from the encoder (proxy). This request-reply sequence is recursive and continues until the decoder at the client proxy is able to decompress the requested data.

In one embodiment, a page template may be created and cached at both the intermediary device and the client proxy. In this instance, provided the page template has not been updated, only dynamic material differs each time a page is requested; if the page template has changed, it will be updated. This could be particularly useful, for instance, if a client frequently requests financial information, such as a bank balance or information about stocks, that is likely to change over relatively short periods of time. While the specific data is likely to change, the underlying page displaying the data probably does not change very much over time. Therefore, if the static elements of the page are compressed and cached, only the dynamic information needs to be sent to the client proxy.

In other embodiments, disclosed in U.S. patent application Ser. No. 10/012,743, the encoder will send uncompressed content along with an identifier when there is no record at the encoder of the identifier being sent to the client proxy. In still other embodiments, other known compression schemes, such as LZW compression, may be used.

Referring again to FIG. 3, the intermediary device sends the compressed webpage to the client proxy (block 58) where it is decompressed. The client proxy scans the webpage for any links to secure webpages (block 38) and rewrites these links before returning the webpage to the client's browser.

1. A method for accelerating delivery of requested secure webpages comprising:
a) receiving a request for a secure webpage, the request made using a link in a first received webpage which has been rewritten from an original format at a client proxy such that any request for the secure webpage made by referencing the rewritten link is recognized by a device intermediating between a client and a server capable of responding to the request for the secure webpage;
b) returning the request to its original format;
c) requesting the secure webpage from the server; and
d) receiving the secure webpage from the server.

2. The method of claim 1 further comprising scanning the first received webpage for any link to a secure webpage.

3. The method of claim 1 further comprising establishing a secure connection between the device and the server responding to the request for the secure webpage.

4. The method of claim 1 wherein an https request in the first received webpage is rewritten to be an http request.

5. The method of claim 1 wherein an https request in the first received webpage is rewritten to include a reference to a subdomain recognized by the device as indicating a request for a secure webpage.

6. The method of claim 5 further comprising establishing a secure connection between the client and the device when the request for the secure webpage is received at the device.

7. The method of claim 1 further comprising returning any received webpage to the client proxy.

8. The method of claim 1 further comprising returning any received webpage to the client.

9. The method of claim 1 further comprising decrypting the secure webpage.

10. The method of claim 1 further comprising compressing the secure webpage.

11. The method of claim 10 wherein compressing the secure webpage includes:
a) compressing data with software acting as an encoder, the software running on a first device in network communication with other devices, the compressed data to be transmitted to a second device in the network running software acting as a decoder, the compressing consisting of representing runs of data with at least one identifier;
b) storing the at least one identifier and corresponding data represented by the at least one identifier in a database associated with the encoder; and
c) transmitting from the encoder to the decoder data corresponding to the at least one identifier when the data is specifically requested by the decoder or when the encoder has no record of the at least one identifier being sent to the decoder.

12. The method of claim 11 further including representing runs of identifiers with a single identifier.

13. The method of claim 11 further including transmitting from the encoder to the decoder only data required to complete a response to the request where the data has not been cached at a second database associated with the decoder.

14. A method for accelerating delivery of requested secure webpages comprising:
a) scanning a webpage to determine whether it contains any links to at least one secure webpage;
b) rewriting any link to at least one secure webpage such that a request for the secure webpage made by referencing the rewritten link is recognized by a device intermediating between a client and a server capable of responding to the request for the secure webpage;
c) delivering the scanned webpage to the requesting client;
d) receiving a rewritten request for a secure webpage at the device, said request based on the rewritten link;
e) returning the request to its original format;
f) requesting the secure webpage from the server; and
g) receiving the requested webpage from the server.

15. The method of claim 14 wherein an https request is rewritten to be an http request.

16. The method of claim 14 wherein an https request is rewritten to include a reference to a subdomain recognized by the proxy as indicating a request for a secure webpage.

17. The method of claim 14 further comprising establishing a secure connection between the device and the server responding to the request for the secure webpage.

18. The method of claim 16 further comprising establishing a secure connection between the client and the device.

19. The method of claim 14 further comprising decrypting the received webpage.

20. The method of claim 14 further comprising compressing the received webpage.

21. The method of claim 14 further comprising returning the received webpage to the client proxy.

22. The method of claim 14 further comprising returning the received webpage to the client.

23. The method of claim 20 wherein compressing the secure webpage includes:
a) compressing data with software acting as an encoder, the software running on a first device in network communication with other devices, the compressed data to be transmitted to a second device in the network running software acting as a decoder, the compressing consisting of representing runs of data with at least one identifier;
b) storing the at least one identifier and corresponding data represented by the at least one identifier in a database associated with the encoder; and
c) transmitting from the encoder to the decoder data corresponding to the at least one identifier when the data is specifically requested by the decoder or when the encoder has no record of the at least one identifier being sent to the decoder.

24. The method of claim 23 further including representing runs of identifiers with a single identifier.

25. The method of claim 23 further including transmitting from the encoder to the decoder only data required to complete a response to the request where the data has not been cached at a second database associated with the decoder.

26. A system for accelerating delivery of requested secure webpages in a network comprising:
a) a client having software means for requesting and receiving secure and nonsecure webpages;
b) a plurality of servers having software means for responding to a client's request for secure and nonsecure webpages;
c) a client proxy having means for rewriting links to any secure webpage in a webpage requested and received by the client, the links rewritten from their original format such that the client's request for a secure webpage based on a rewritten link is recognized as a request for a secure webpage by a device intermediating between the client and the plurality of servers; and
d) a device intermediating between the client and the plurality of servers, the device having software means for recognizing the rewritten request for a secure webpage, returning the request to its original format, and using the original request to obtain the secure webpage from one of the plurality of servers.

27. The system of claim 26 further comprising the client proxy having means for delivering a requested webpage to the client.

28. The system of claim 26 further comprising the device having means for delivering a requested webpage to the client proxy.

29. The system of claim 26 further comprising the client proxy having means for scanning the received webpage for any links to a secure webpage.

30. The system of claim 26 further comprising the device having means for setting up a secure connection between the device and the server responding to the request for the secure webpage.

31. The system of claim 26 wherein the means for rewriting links to any secure webpage rewrites an https request is to be an http request.

32. The system of claim 31 wherein the means for rewriting links to any secure webpage rewrites an https request to include a reference to a subdomain recognized by the device as indicating a request for a secure webpage.

33. The system of claim 32 further comprising the client having means for establishing a secure connection between the client and the device.

34. The system of claim 26 wherein the client and device are members of a private network.

35. The system of claim 26 wherein the server is a member of a public network.

36. The system of claim 26 further comprising the device having means for decrypting the webpage.

37. The system of claim 26 further comprising the device having means for compressing the webpage.

38. The system of claim 37 further comprising the client proxy having means for decompressing the webpage.
